(19) United States
(12) Patent Application Publication
(10) Pub. No.: US 2007/0278289 A1
(43) Pub. Date: Dec. 6, 2007

(54) Payment adjusting apparatus and program therefor

(75) Inventors: Shigetosi Kunieda, Kanagawa-ken (JP); Kouichi Sano, Shizuoka-ken (JP); Katsunori Matsushita, Shizuoka-ken (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: TOSHIBA TEC KABUSHIKI KAISHA, Tokyo (JP)

(21) Appl. No.: 11/443,287

(22) Filed: May 31, 2006

(51) Int. Cl. G06K 5/00

(52) U.S. Cl. 235/380

(57) ABSTRACT

A payment adjustment apparatus having an interface that receives an electronically watermarked image, in which an electronic-value information is embedded, extracts the electronic-value information out of the electronically watermarked image by an extracting means, adjusts a payment by subtracting an amount of a price of a purchased article from a value in the electronic-value information by a payment adjusting means, if the amount of the value in the electronic-value information is greater than the price of the purchased article. Thereafter, an updating means of the apparatus updates the contents of the electronic-value information received by the receiving means based on the balance resulted from the payment adjustment performed by the payment adjusting means.

### BACKGROUND OF THE INVENTION

1. Field of the Invention

The present invention relates to a payment adjusting apparatus by which payment is made using an electronic value contained in vehicles such as electronic money, electronic coupon, or electronic ticket.

2. Description of the Related Art

Conventionally, there have been systems that embed ticket information including a ticket number and others in an electronic image through an electronic watermarking technique and transmit such an electronic image to a mobile terminal. Such systems have a function of detecting unduly duplicated ticket information to prevent use of such information. That is, the systems read an electronic image incorporating a ticket number and authenticate the ticket number as ticket information embedded within the image. Such system is disclosed in the Japanese laid-open patent application No. 2001-256513, for example.

However, there arises a problem in which the function of only authenticating an electronic money in such a system, when used as a payment system, cannot prevent one electronic money from being repeatedly used.

### BRIEF SUMMARY OF THE INVENTION

The payment adjusting system according to the present invention comprises receiving means for receiving an electronically watermarked image in which an electronic value is embedded, extracting means for extracting the electronic-value information out of the electronically-watermarked image, adjusting means for adjusting payment using a value contained in the electronic-value information extracted by the extracting means, and updating means for updating the contents of the electronic-value information received from the receiving means in respect to the value information based on a balance resulted from the payment adjustment performed by the adjusting means.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram illustrating a structure of a whole system that uses a payment apparatus according to the first embodiment of the present invention;

FIG. 2 is a block diagram illustrating a structure of a server according to the first embodiment of the present invention;

FIG. 3 is a block diagram illustrating a structure of a POS terminal according to the first embodiment of the present invention;

FIG. 4 is a block diagram illustrating a structure of a cellular phone according to the first embodiment of the present invention;

FIG. 5 is a flowchart illustrating operations of the server and cellular phone when purchasing an electronic value according to the first embodiment of the present invention;

FIG. 6 is a flowchart illustrating operations performed by the POS terminal, server, and cellular phone when adjustment is made using an electronic value according to the first embodiment of the present invention;

FIG. 7 is a block diagram illustrating a structure of a POS terminal according to the second embodiment of the present invention;

FIG. 8(a) is a flowchart illustrating operations performed by the POS terminal, and server when adjustment is made using an electronic value according to the second embodiment of the present invention;

FIG. 8(b) is a flowchart illustrating operations performed by the cellular phone when adjustment is made using an electronic value according to the second embodiment of the present invention;

FIG. 9 is a block diagram illustrating a structure of a server according to the third embodiment of the present invention;

FIG. 10 is a block diagram illustrating a structure of a POS terminal according to the third embodiment of the present invention;

FIG. 11 is a block diagram illustrating a structure of a cellular phone according to the third embodiment of the present invention;

FIG. 12 is a flowchart illustrating operations of the server and cellular phone when purchasing an electronic value according to the third embodiment of the present invention; and

FIG. 13 is a flowchart illustrating operations performed by the POS terminal, server, and cellular phone when adjustment is made using an electronic value according to the third embodiment of the present invention.

### DETAILED DESCRIPTION OF THE INVENTION

Embodiments according to the present invention will be described below in reference to the accompanying drawings.

### First Embodiment

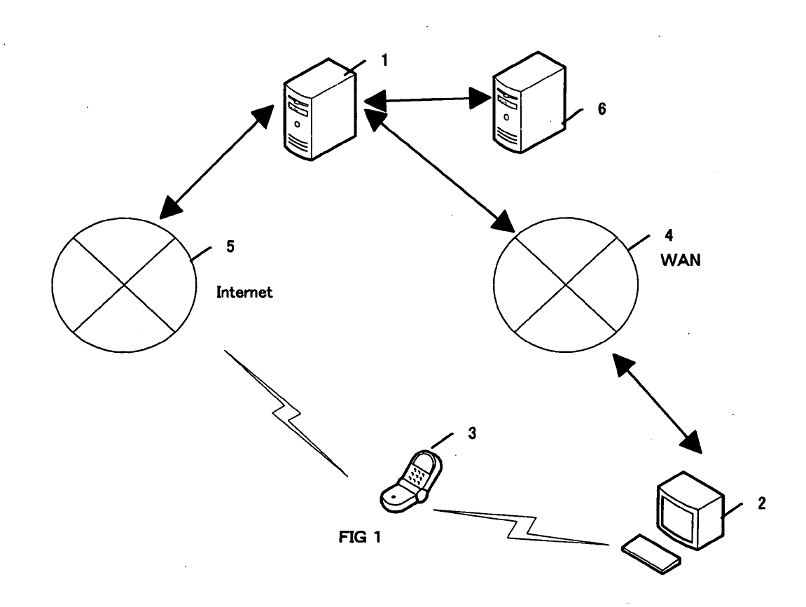

The first embodiment will be explained using FIGS. 1 through 6.

FIG. 1 shows a structure of a whole system embodying the present invention. The system comprises a server 1, a POS (point of sale) terminal 2 as a payment adjusting apparatus, a cellular phone 3 as a mobile terminal, database 6 for holding data from server 1. Cellular phone 3 communicates with server 1 over the Internet 5, and it also communicates with POS terminal 2 using a radio-communication technique. The mobile terminal may be a PDA (Personal Digital Assistance) in exchange for a cellular phone. Server 1 and POS terminal 2 can communicate with each other through a WAN (Wide Area Network) 4. Such communication network may be the Internet or a LAN (Local Area Network) instead of a WAN.

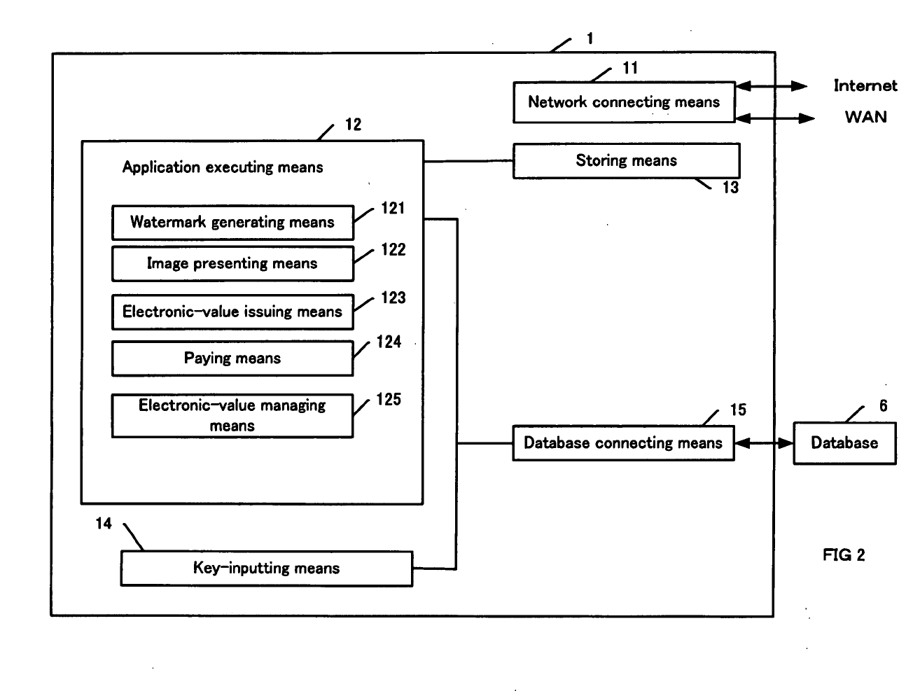

Server 1 includes, as shown in FIG. 2, a network connecting means 11 that controls connections to WAN 4 and the Internet 5, and an application executing means 12, containing CPU, ROM, RAM, which executes various software applications, a storing means 13 including a rewritable memory, a key-inputting means 14 inputting by keys, a database connecting means 15 that communicates with database 6, and they are electrically interconnected with each other on bus lines.

Application executing means 12 includes, in order to execute various software applications, a watermark generating means 121, an image presenting means 122, an electronic-value issuing means 123, a paying means 124, and an electronic value managing means 125. Watermark generating means 121 has a function of generating an electronically watermarked image incorporating electronic-value information in an electronic image. Image presenting means 122 has a function of presenting an electronic image retained in storing means 13 to cellular phone 3.

Electronic-value issuing means 123 has a function of producing and issuing electronic-value information. The electronic value refers to, for example, electronic money. It may be a value contained in an electronic gift ticket or electronic ticket including an electronic coupon. Paying means 124 has a function of serving to settle a payment using an electronic value received from cellular phone 3. Electronic value managing means 125 has a function of managing electronic values that are issued.

Now, some examples of a data structure of electronic-value information issued by electronic-value issuing means 123 will be explained. Data of electronic-value information is comprised of an ID for identifying an electronic value, value information, and electronic signature. The value information indicates an amount of a usable value. The value information, in some cases, is indicated with numeral “0” meaning that the value has been used up. The electronic signature is created by encoding a signature using a cryptgraphic key.

Next, the operation of payment performed by paying means 124 will be explained. In the case of payment using a credit card, paying means 124 transmits a credit-card number received from cellular phone 3 to a computer of a credit-card issuer over the Internet 5. Paying means 124 also transmits information on a relevant commercial article to the computer of the credit-card issuer over the Internet 5.

Next, a function of electronic value management performed by electronic value managing means 125 will be described. Electronic value managing means 125 registers an image used for an electronic watermark and value information in electronic-value information. Also, electronic value managing means 125 updates the current value information reflecting an amount that has been spent, and information on a store name and article(s) according to purchase experience by the user.

Next, electronic value management information managed by electronic value managing means 125 will be explained. The management data includes information regarding IDs, names of electronic images, values information, current statuses, store names used, and actual electronic image data. Electronic value managing means 125 may manage information relating an attribute inputted by a purchaser to an electronic value at the time of purchasing that electronic value through cellular phone 3. This management data is stored in database 6.

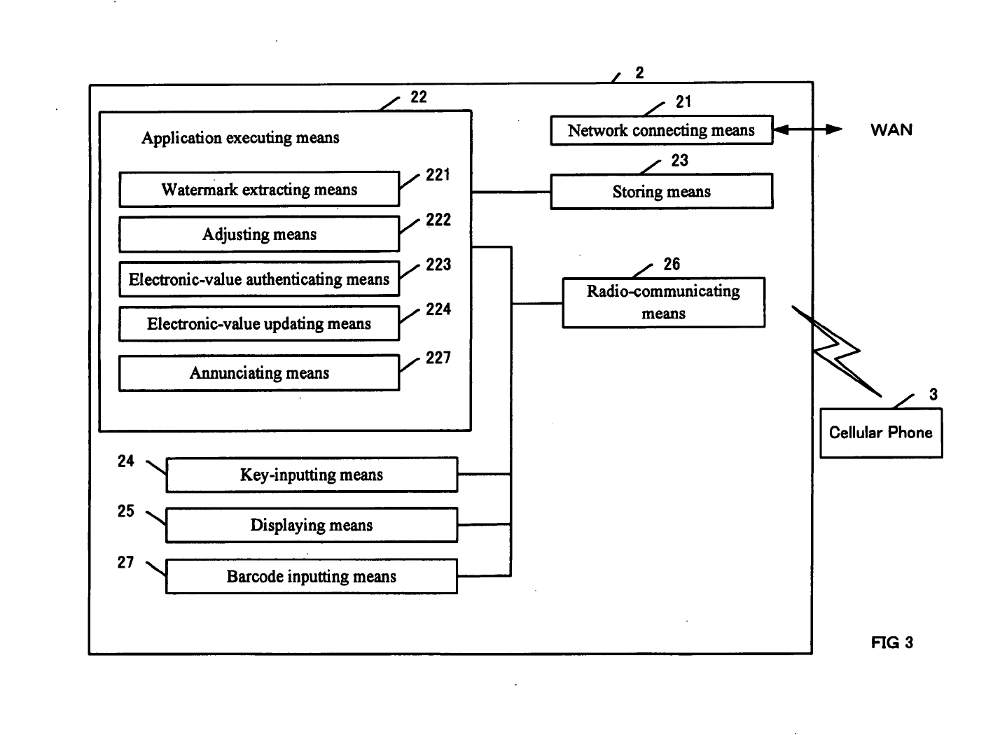

POS terminal 2, as shown in FIG. 3, a network connecting means 21 that controls a connection to WAN 4, an application executing means 22, including a CPU, ROM, RAM, which executes various software applications, a storing means 23 comprising a rewritable memory, an inputting means 24 performing key-input, a displaying means 25 that displays information such as an electronic image and text data, a radio-communicating means 26 that communicates with cellular phone 3 using a radio-communication technique, and a barcode inputting means 27 that inputs barcode data, and they are electrically interconnected with each other on the data bus.

Application executing means 22 comprises, in order to execute various software applications, a watermark extracting means 221, an adjusting means 222, an electronic value authenticating means 223, an electronic value updating means 224, and an annunciating means 227. Watermark extracting means 221 has a function of extracting an electronic-value information out of an electronically watermarked image transmitted from cellular phone 3. That is, it extracts value information out of the electronically watermarked image. Adjusting means 222 has a function of acquiring value information of a purchased article or a sum of the values if a plurality of commercial articles are purchased, based on information inputted through barcode inputting means 27, and displays it on a displaying means 25. Adjusting means 222 has a function of subtracting the amount sum of articles from an available amount stored in the value information that is extracted by watermark extracting means 221 and a function of adjusting the payment by cash. Electronic value authenticating means 223 has a function of authenticating the electronic-value information extracted out of the value-containing image. Electronic value updating means 224 has a function of obtaining an available balance by subtracting an amount of the spending from the valued amount in the electronic-value information. Electronic value updating means 224 also has a function of performing a necessary operation to generate a new electronic signature associating with the updated value information. Annunciating means 227 has a function of transmitting the updated electronic-value information to server 1.

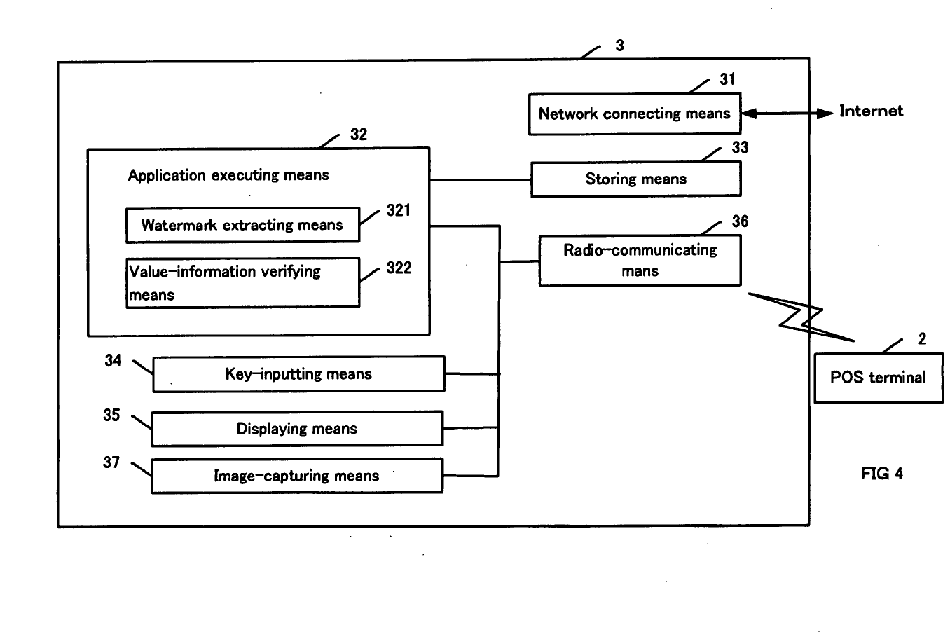

Cellular phone 3 comprises, as shown in FIG. 4, a network connecting means 31 controlling connection to the Internet 5, an application executing means 32 containing CPU, ROM, RAM that executes various software applications, a storing means 33 comprising a rewritable memory, a key-inputting means 34 performing key-inputting, a displaying means 35 that displays information such as an electronic image and text data, a radio-communicating means 36 that communicates with POS terminal 2 using a radio-communication technique, and an image-capturing means 37 such as a camera having a CCD (Charge-Coupled Device) as a photographing device, and they are electrically interconnected with each other on the data bus.

Application executing means 32 comprises a watermark extracting means 321 that extracts electronic-value information out of an electronically watermarked image, a value-information verifying means 322 that examines value information if a value in the value-information has been used up.

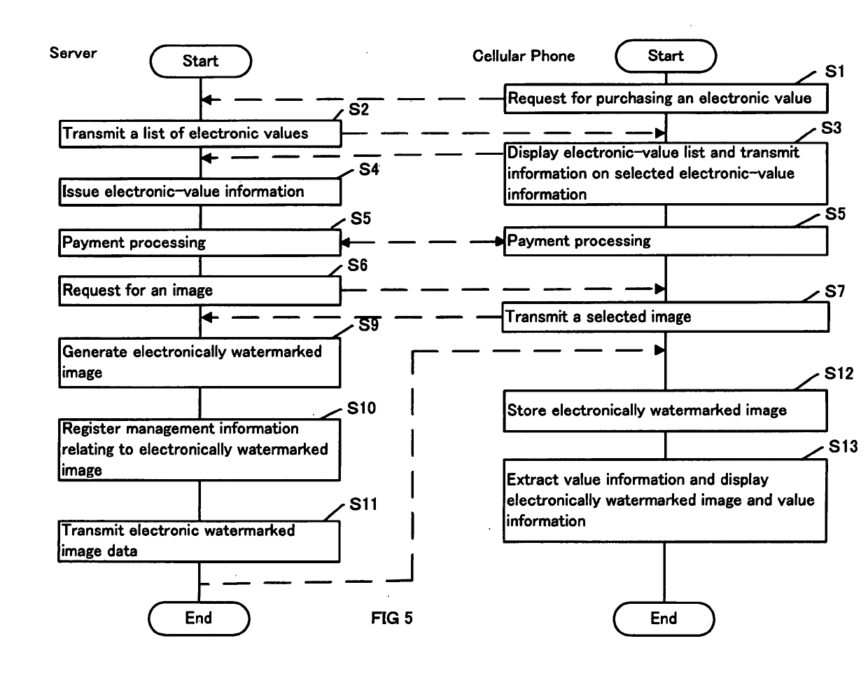

Now, in reference to FIG. 5, there will be described about operations performed between an application executing means 32 of cellular phone 3 and application executing means 12 of server 1 at the time of purchasing an electronically watermarked image incorporating electronic-value information.

First, cellular phone 3 makes displaying means 35 display the electronic value purchasing screen and issues a request of purchase to server 1 according to the instruction shown (step 1, hereinafter referred to as “S1”). Having received the purchase request from cellular phone 3, server 1 sends back a list of available electronic values to cellular phone 3 (S2). “The list of available electronic values” in this case indicates electronic values that become usable after their purchase. Displaying means 35 of cellular phone 3 then displays the list of purchasable electronic values received from server 1 on the screen, and cellular phone 3 sends information on a subsequently selected electronic value to server 1 (S3). Server 1 issues an electronic-value based on the information of the selected electronic value received from cellular phone 3 (S4).

Next, server 1 and cellular phone 3 perform the process of payment (S5). A description will be made below in detail, taking the case where the payment is made using a credit card. First, server 1 requests a credit card number to cellular phone 3. Then, cellular phone 3 returns information on the credit number to server 1. Server 1, having received the information on the credit card number from cellular phone 3, confirms with the related card issuer through a computer of the company for the information on the credit card number, and waits a reply of the confirmation. If the reply from the card issuer confirms legitimate credit card holder, the process of payment is terminated.

With the payment process S5 completed, server 1 requests a transmission of an electronic image to cellular phone 3 (S6). Receiving the request of an electronic image from server 1, cellular phone 3 makes displaying means 25 display a list of selectable electronic images and transmits a selected image to server 1 (S7). “Selectable electronic images” referred herein are acquired by image-capturing means 37. These selectable electronic images may also be ones in a list that are transmitted from server 1.

Having received the selected electronic image from cellular phone 3, server 1 generates an electronically watermarked image by watermark generating means 121, incorporating the electronic-value, for which purchase proceeding has been made, into the received electronic image through an electronic watermarking technique (S9). This electronically watermarked image generated here by the image generating means is referred to as the “first electronically watermarked image.” In this method of electronic watermarking, a least significant bit of pixel data is embedded, wherein each pixel of an electronic image is represented by 8-bit data. Subsequently, server 1 registers management information relative to this electronically watermarked image in database 6 (S10). Server 1 then transmits this electronically watermarked image data to cellular phone 3 (S11).

Upon a receipt of this electronically watermarked image data, cellular phone 3 stores the data in storing means 33 (S12). Watermark extracting means 321 extracts an electronic-value information incorporated in the electronically watermarked image data, then picking up value information in the electronic-value information, and makes displaying means 35 display the electronic image and the value information on the screen (S13).

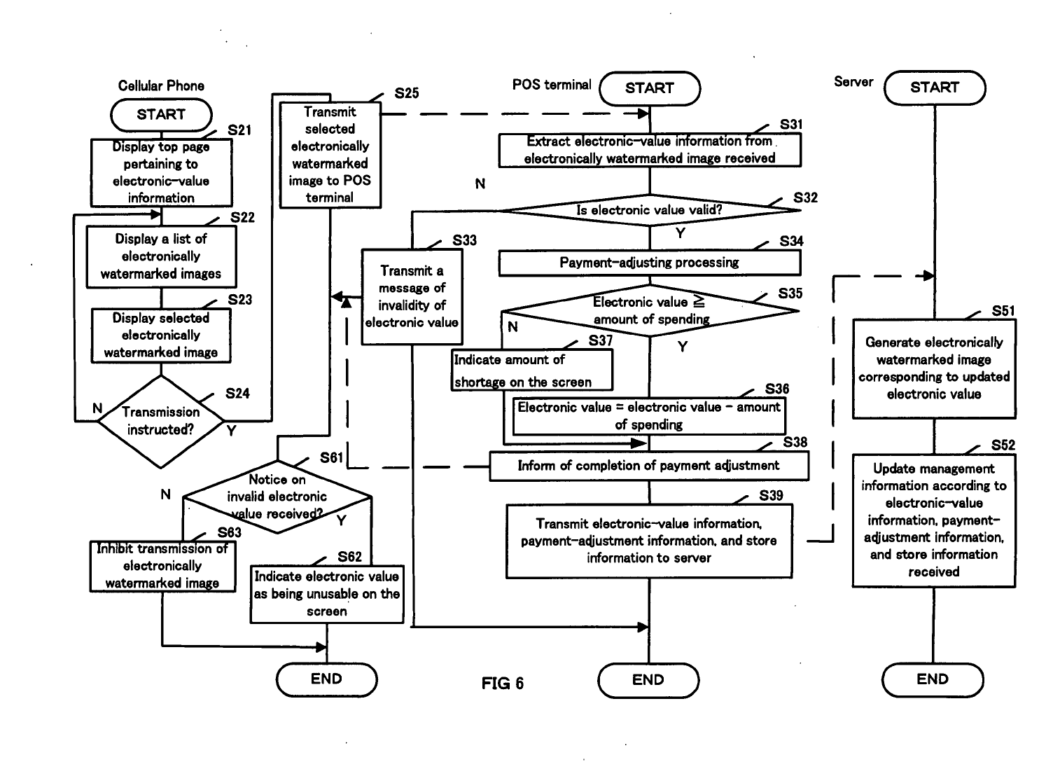

Now, the process of adjustment performed by application executing means 22 of POS terminal 2 will be explained. In reference to FIG. 6, the respective processes performed by application executing means 32 of cellular phone 3 and application executing means 12 of server 1, which are operated being associated with the operation by application executing means 22 of POS terminal 2, will also be described along with the operation of application executing means 22.

Cellular phone 3 makes displaying means 35 display the top page relating to an electronic-value information (S21). This electronic-value relating top page allows a user of cellular phone 3 to select an image from the displayed items to use or purchase a value. When user indicates use of the electronic values on the display, cellular phone 3 reads a list of electronically watermarked images stored in storing means 33 and display the list through displaying means 35 (S22). At the same time, the value information associated with the watermarked images is also read out from storing means 33 and displayed on the same screen through displaying means 35 (S22). If such electronic watermark information stored in storing means 33 is multiple, all the information are displayed by displaying means 35.

When one item is selected out of the plurality of electronic watermarked images displayed on displaying means 35, cellular phone 3 displays that selected watermarked image on displaying means 35. At this time, displaying means 35 simultaneously displays the selected watermarked image, value information associating with the selected image, transmit-button, and retry button (S23). Cellular phone 3 waits and recognizes an instruction of transmission of the selected watermarking image (S24). When the instruction of transmission is recognized (S24-Y), cellular phone 3 transmits the selected electronically watermarked image including the associating electronic-value information to POS terminal 2 (S25). If cellular phone 3 judges that the instruction made is other than the image transmission (S24-N), cellular phone 3 takes the case as being “retry,” and returns to the process in S22.

Having recognized the reception of the selected electronically water marked image including the associating electronic-value information from cellular phone 3, the watermark extracting means 221 of POS terminal 2 extracts the electronic-value information out of the electronically watermarked image received (S31). The electronic value authenticating means 223 verifies the value in the electronic-value information received (S32). That is, a value encoded within a region of the electronic signature is decoded and the electronic-value information received is compared with the decoded value in the signature region. If the two values coincide, the received electronic value is judged to be legitimate. If the received electronic value is judged to be invalid (S32-N), the POS terminal informs cellular phone 3 of the invalidity of the electronic value, and terminates the process (S33).

Meanwhile, if the received electronic value is found to be legitimate (S32-Y), an adjusting means 222 is enabled and the program proceeds to the adjustment process. Adjusting means 222 acquires price information of the purchased commercial article from information inputted by barcode inputting means 27. If multiple articles are purchased, a sum of prices of the respective commercial articles is calculated. Adjusting means 222 then makes displaying means 25 display the calculated total amount on the screen (S34).

A purchased commercial article or articles and their price(s) constitute “Adjustment information.” Subsequently, an electronic value updating means 224 is enabled. Electronic value updating means 224 checks the value extracted out of the electronically watermarked image data that has been received to see if the value received is greater than the price of the purchased commercial article (S35). If the value contained in the received electronic-value information is found to be equal or more than the amount of the price(s) of the purchased commercial article(s) (35-Y), electronic value updating means 224 subtracts the amount of the price from the current value of the electronic-value information and defines the resulted balance to be a “to be renewed value” of the electronic-value information (S36). If the value contained in the received electronic-value information is found to be less than the amount of the price(s) of the purchased commercial article(s) (35-N), electronic value updating means 224 clears the value of the electronic-value information to zero and makes displaying means 25 display the amount of the shortage on the screen (S37).

In the case that any shortage in the electronic value results, an operation for appropriate adjustment is carried out using the adjustment means. When the process by adjusting means 222 has been completed, POS terminal 2 informs cellular phone 3 of the receiving source that the adjustment process is done (S38). This notification is made by an annunciating means 227. The updated electronic-value information and article-purchased store information are transmitted to server 1 (S39). This notice on the completion of the adjustment process to cellular phone 3 may be transmitted before electronic value updating means 224 starts to operate.

Having received the updated electronic-value information and the store information relative to store at which the commercial article is purchased from POS terminal 2 over a WAN 4, server 1 generates a new electronically watermarked image by incorporating the updated value information associated with the relative ID into an electronic image (S51). At this time, the electronic signature is also updated. This renewed electronically watermarked image is referred to as the “second electronically watermarked image.” The server acquires purchased commercial articles from the adjusting information, available stores from the store information, and current value information from the updated electronic-value information that have been received (S52), and updates the management information where applicable in the database 6.

On the other hand, cellular phone 3 checks if the contents received from POS terminal 2 is about the illegitimate electronic value (S61). If the received information is about illegitimate electronic value (S61-Y), displaying means 35 of the cellular phone displays a message indicating that the related electronic value is invalid for use (S62). If cellular phone 3 has found that the received contents differs from the notification about invalid electronic value (S61-N). That is, cellular phone 3 takes it that the notification is about completion of the adjustment process, and inhibits transmission of the current electronically watermarked image thereafter (S63).

By thus embedding electronic-value information in an electronic image using an electronic watermarking technique, a user can has an added value as contents of an electronic image together with an electronic value. The user can make payment at POS terminal 2 using such electronic-value information embedded in an image. Besides, since dedicated software applications are required to extract the electronic-value information out of the electronic image, stores using such electronic-value information can safely manage their businesses having sufficient security.

### Second Embodiment

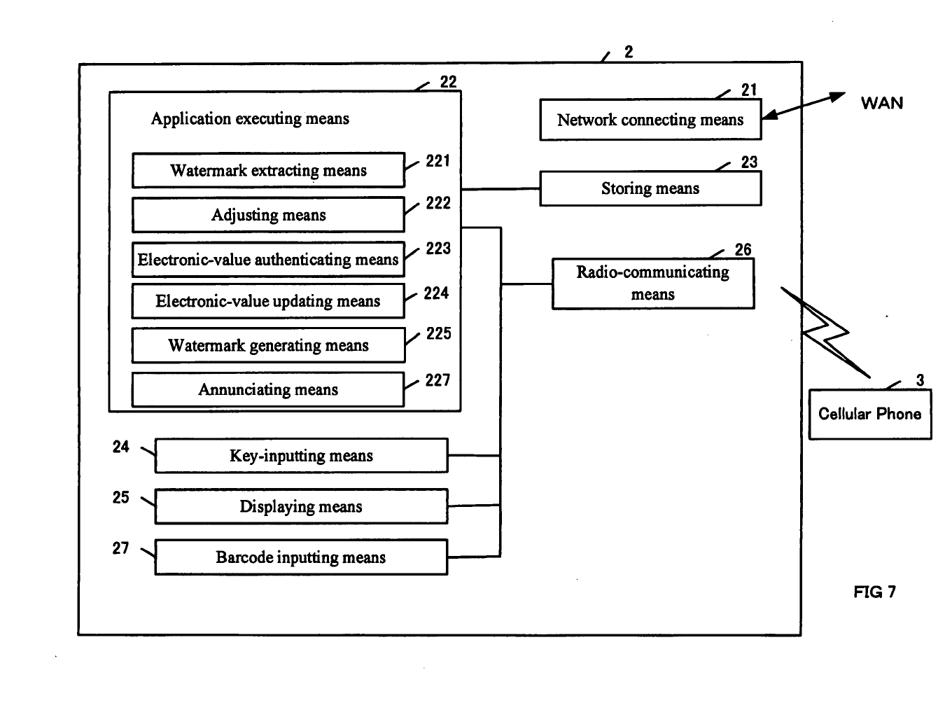

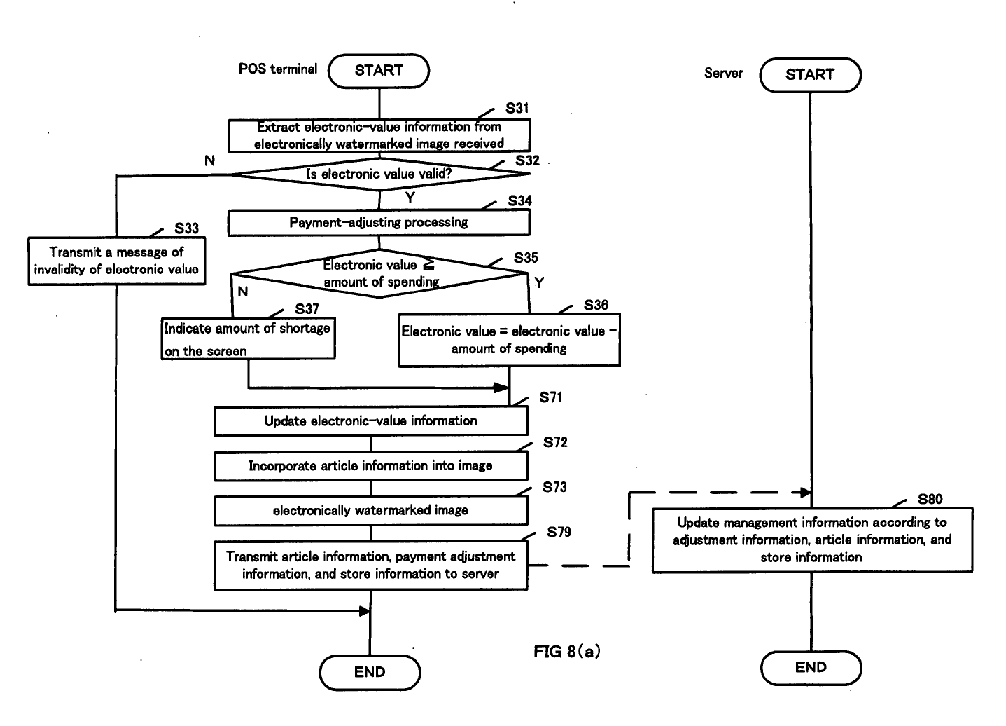

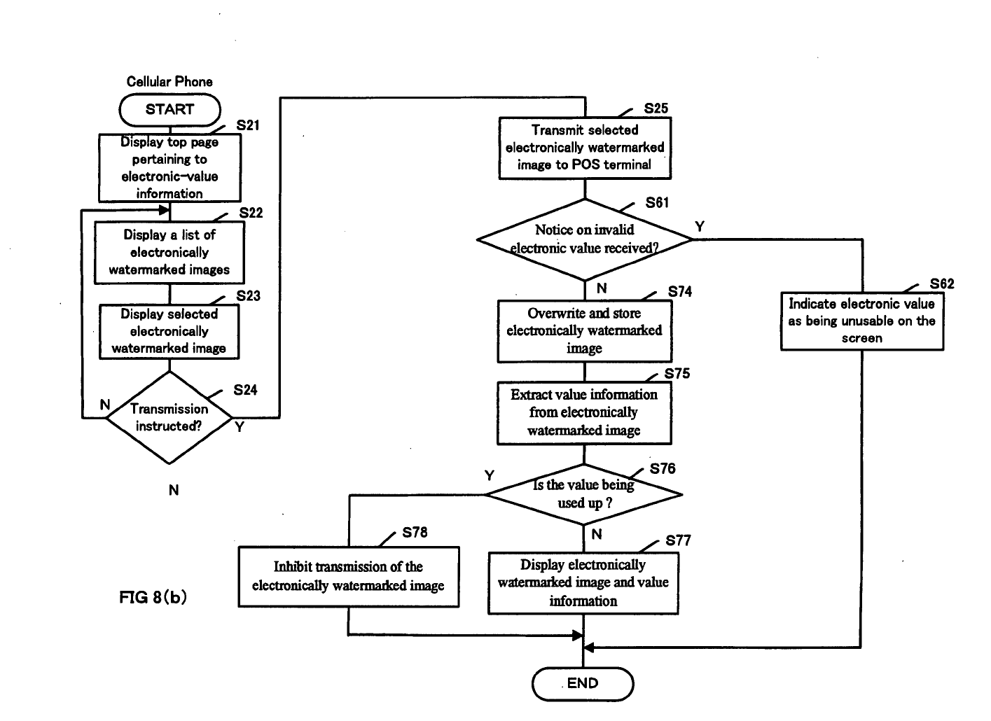

A second embodiment of the present invention will next be described in reference to FIGS. 7 and 8. FIG. 8 is composed of FIG. 8(a) and FIG. 8(b). Elements in these FIGURES common with those in the first embodiment are identified by the same reference numerals as in the first embodiment, and description therefor will be omitted accordingly. This embodiment is characterized by updating an electronically watermarked image in POS terminal 2.

FIG. 7 is an electrical block diagram of POS terminal 2 according to the second embodiment of the present invention. Application executing means 22 includes a watermark generating means 225 that generates an electronically watermarked image incorporating electronic-value information thereinto.

Next, a description will be made for “Adjustment process” carried out by application executing means 22 of POS terminal 2 in reference to FIG. 8. Along with the operation of application executing means 22, operation of application executing means 32 of cellular phone 3 operated associating with POS terminal 2 and that of application executing means 12 of server 1 will also be explained using the same FIG. 8.

A series of processes performed in cellular phone 3 from step S21 at which displaying means 35 displays the top page pertaining to electronic-value information to step S25 at which a selected electronically watermarked image is transmitted to POS terminal 2 are the same as in the first embodiment, and therefore descriptions for these processes will be omitted here. Similarly, descriptions for the processes of POS terminal 2 from step S31 operated by watermark extracting means 221 to step S37 operated by electronic value updating means 224 will also be omitted by the same reason.

After completing the process at step S36 or S37, the current electronic-value is updated by subtracting a total amount of the purchased articles from an amount of the electronic value received or by zeroing the current value indicating the value as “being used up,” respectively (S71). Watermark generating means 225 generates a revised electronically watermarked image through an electronic watermarking technique by incorporating the updated electronic value into the previous image from which a value in the electronic-value information has been extracted (S72). At this time, the “electronic signature” region is also updated. This revised electronically watermarked image is referred to as the “second electronically watermarked image.” Subsequently, application executing means 22 transmits this second electronically watermarked image to cellular phone 3 (S73). After transmitting the second electronically watermarked image to cellular phone 3, POS terminal 2 transmits to server 1 the updated electronic-value information, information of the adjusted result, and related store information (S79).

Having received the updated electronic-value information and the adjustment information from POS terminal 2 through WAN 4, server 1 acquires the purchased article(s) from the adjustment information received, used store name from the store information, and the current value information from the received electronic-value information (S80). Then, a relative part in the management information in the relative database 6 is updated.

On the other hand, cellular phone 3 checks whether the contents received from POS terminal 2 is one relating to the illegitimate electronic-value information or others (S61). If cellular phone 3 has judged that what it has received is a notice on illegitimate electronic-value information (S61-Y), displaying means 35 of cellular phone 3 displays a message on the screen indicating that the related electronic-value information is invalid (S62). If cellular phone 3 has judged that what it has received is other than the message of the illegitimate electronic-value information (S61-N), i.e. the second electronic-value information, cellular phone 3 overwrites the second electronic-value information at a related location in storing means 33 (S74). Watermark extracting means 321 extracts electronic-value information out of the second electronic-value information received (S75). Value-information verifying means 322 examines if the electronic-value information extracted by watermark extracting means 321 indicates that it is used up, that is, the value is “zero” (S76). If the value is still valid to be usable (not “zero”) (S76-N), displaying means 35 of cellular phone 3 displays the current electronic-value and the corresponding electronically watermarked image (S77). If value-information verifying means 322 judges it as being used-up (S76-Y), an action is taken so as to inhibit further transmission of the electronically watermarked image (S78).

By thus updating the electronically watermarked image in POS terminal 2, the possibility that a user separately receives the updated electronically watermarked image from server 1 can be avoided, and the user can continue to use the electronically watermarked image incorporating the revised value at different stores.

### Third Embodiment

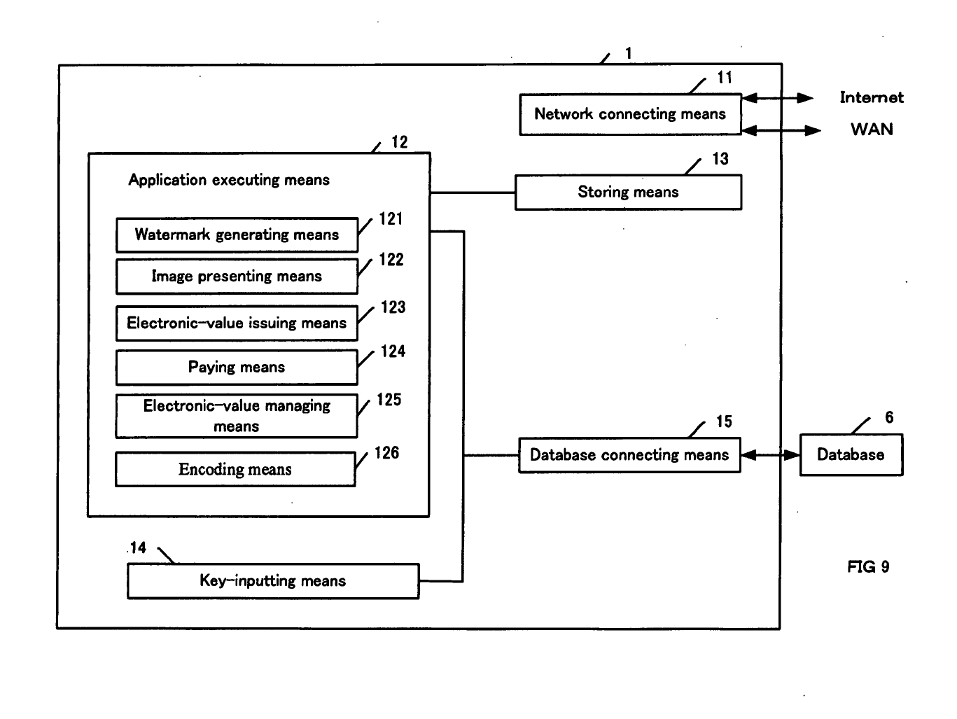

The third embodiment of the present invention will next be described in reference to FIGS. 9 through 13. Elements therein common with those in the first embodiment bear the same reference numerals as in the first embodiment, and descriptions therefor will be omitted accordingly. This embodiment is characterized by the following.

First, server 1 encodes and embeds a whole electronic-value information in an electronic watermark image. Then, cellular phone 3 receives the electronically watermarked image incorporating electronic-value information, decodes the whole electronic-value information, and extracts the value from the value information. Meanwhile, POS terminal 2 receives the electronically watermarked image as is encoded from cellular phone 3 and processes the watermarked image to decode it into electronic-value information.

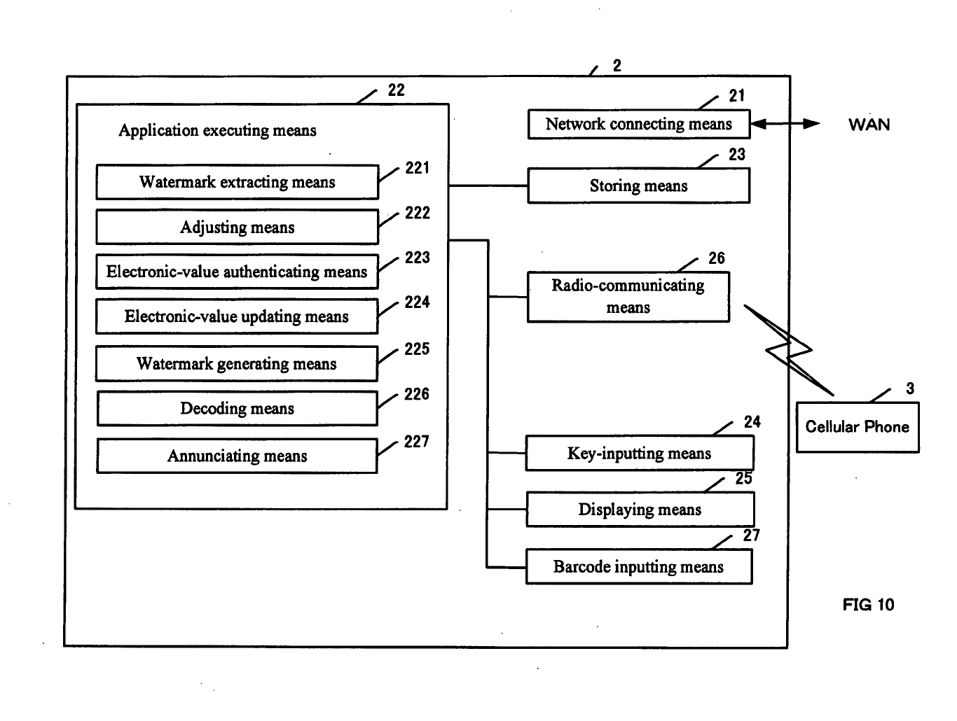

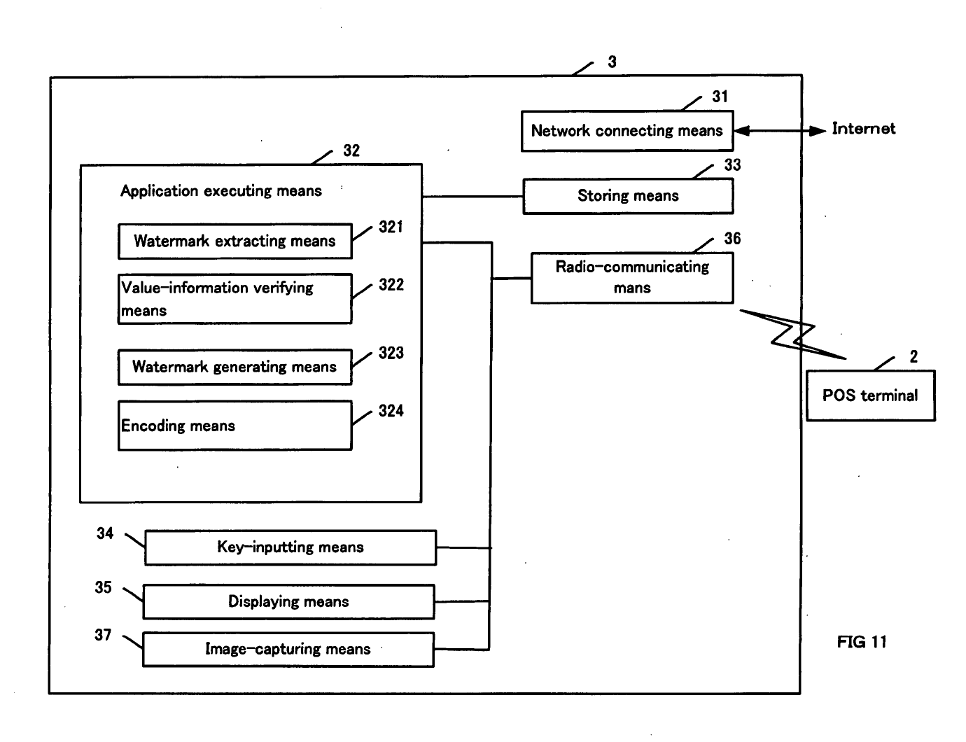

FIG. 9 is an electrical block diagram illustrating a structure of server 1 according to the third embodiment of the present invention. FIG. 10 is an electrical block diagram illustrating a structure of POS terminal 2 according to the third embodiment. FIG. 11 is an electrical block diagram illustrating a structure of cellular phone 3 according to the third embodiment.

In reference to FIG. 9, application executing means 12 includes an encoding means 126 that encodes an electronic-value information using a cryptographic key. A whole electronic-value information is encoded. In reference to FIG. 10, application executing means 22 includes an encoding means 226 that encodes an electronic-value information using a cryptographic key; in reference to FIG. 11, application executing means 32 includes an encoding means 324 that encodes an electronic-value information using a cryptographic key.

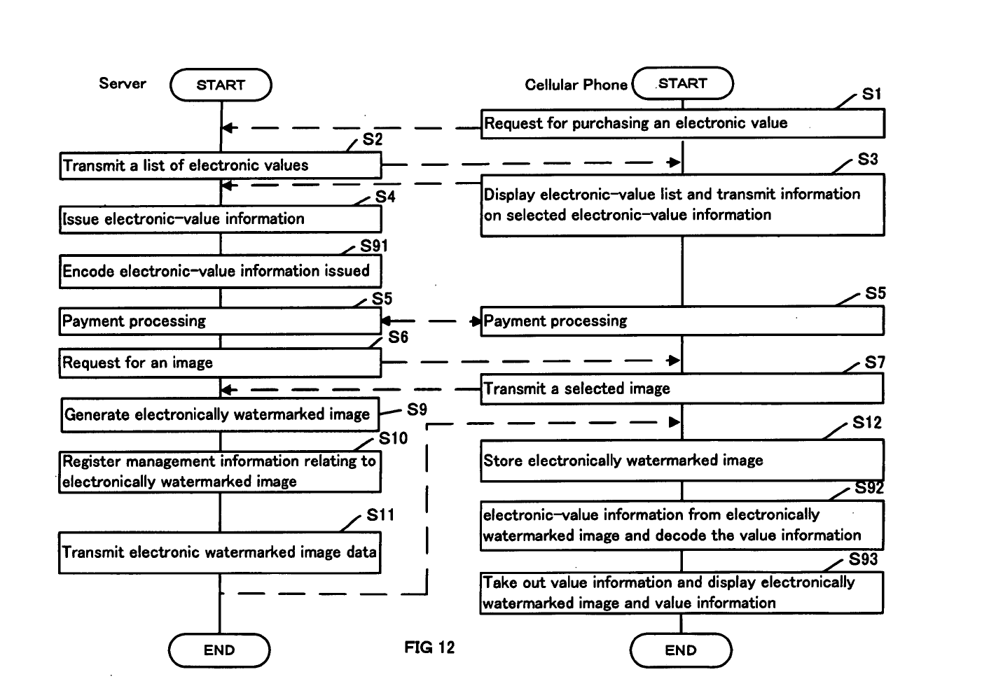

In reference to FIG. 12, a description will be made for operations performed by application executing means 32 of cellular phone 3 and application executing means 12 of sever 1 when an electronically watermarked image including encoded electronic-value information is purchased. The steps up to S4 carried out in server 1 are the same as in the first embodiment, and hence the descriptions for them will now be omitted. After having issued the electronic-value information at step S4, server 1 encodes the part of electronic signature within the issued electronic-value information using a cryptgraphic key (S91). After finishing this encoding process, server 1 performs payment process (S5). Operations of server 1 thereafter are the same as in the first embodiment, and therefore the related descriptions will now be omitted. Processes performed in cellular phone 3 up to S12, where an electronic image data is stored in the memory, are also the same as in the first embodiment, and therefore the related descriptions will now be omitted. After having stored electronically watermarked image in S12, cellular phone 3 extracts the electronic-value information out of the electronically watermarked image by watermark extracting means 321, and encodes the part of electronic signature within the electronic-value information (S92). Then, the electronic signature is taken out from the decoded electronic-value information and displayed on the screen by displaying means 35 (S93).

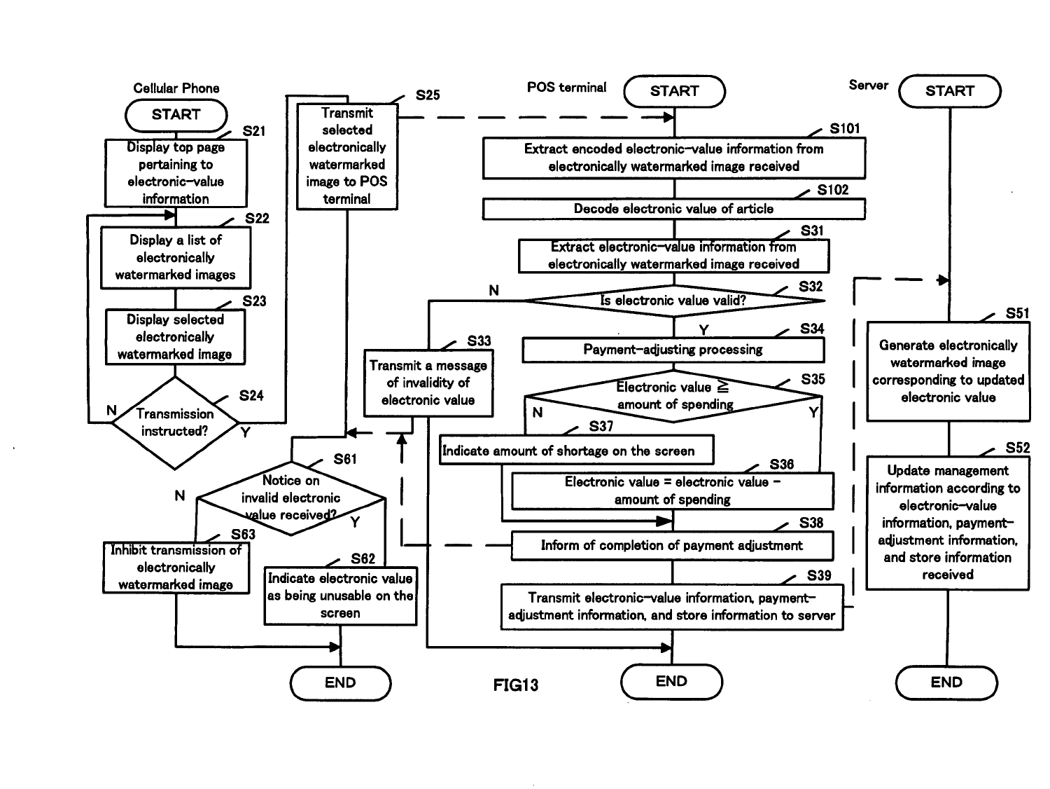

The process of “payment adjustment” performed by application executing means 22 of POS terminal 2 will now be described. Along with application executing means 22, application executing means 32 of cellular phone 3 and application executing means 12 of server 1 that are operated associating with POS terminal 2 will next be described in reference to FIG. 13. The process flows in server 1 and cellular phone 3 are the same as in the first embodiment, and therefore, the description for them will now be omitted. This embodiment differs from the first embodiment in respect that, at step S25, article information included in the electronically watermarked image is transmitted to POS terminal 2 as being encoded.

After POS terminal 2 has received the encoded electronic-value information, watermark extracting means 221 extracts the electronic-value information out of the electronically watermarked image (S101). A decoding means 226 decodes the part of electronic signature within the extracted electronic-value information (S102). The received electronic-value information is authenticated to see if it is legitimate (S32). Since the processes after step S32 are the same as in the first embodiment, descriptions for them will now be omitted.

In this embodiment, descriptions have been made assuming that various functions realizing the present invention are stored within the apparatus. However, software programs having the same functions may be downloaded through a network, without restricting the method to the abovementioned. As an alternative, software programs executing similar functions stored in a storage medium may be installed into the apparatus. This storage medium can be of any type such as a CD-ROM, as log as it can store such programs and the contained programs can be read into the apparatus. Such functions that can be attained by pre-installation or downloading may be realized by cooperating with an operating system within the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A payment adjusting apparatus comprising:
receiving means for receiving from a mobile terminal an electronically watermarked image in which an electronic-value information is embedded;
extracting means for extracting the electronic-value information out of the electronically watermarked image;
adjusting means for adjusting a payment based on an amount of a value in electronic-value information received by said receiving means; and
updating means for updating the contents of the electronic-value information received by said receiving means in respect to the electronic-value information based on a balance resulted from payment adjustment performed by said adjusting means.

2. A payment adjusting apparatus according to claim 1 further comprising electronic-value information authenticating means for authenticating the electronically watermarked image received from said receiving means.

3. A payment adjusting apparatus in claim 2, wherein said electronic-value information authenticating means authenticates the electronically watermarked image by comparing the value information stored in the electronic-value information with an electronic signature into which the value information is encoded using a cryptographic key.

4. A payment adjusting apparatus according to claim 1 further comprising annunciating means for annunciating completion of a process of the payment adjustment to said mobile terminal, annunciating completion of the process causing said mobile terminal to inhibit further transmission of the electronic-value information from said mobile terminal after said adjusting means has completed the process of the payment adjustment.

5. A payment adjusting apparatus according to claim 1 further comprising transmitting means for transmitting the electronic-value information updated by said updating means to an external device.

6. A payment adjusting apparatus according to claim 1 further comprising electronic image generating means for generating a revised electronically watermarked image incorporating the electronic-value information updated by said updating means thereinto.

7. A payment adjusting apparatus according to claim 1 further comprising an image generating means for generating a second electronically watermarked image into which the electronic-value information updated by said updated means is incorporated, assuming the electronically watermarked image extracted by said extracting means to be a first electronically watermarked image.

8. A payment adjusting apparatus according to claim 7 further comprising transmitting means for transmitting to an external device the second electronically watermarked image generated by said image generating means.

9. A payment adjusting apparatus according to claim 1 further comprising decoding means for decoding the electronic-value information received by receiving means, the electronic-value information received by receiving means being encoded.

10. A payment adjusting apparatus comprising:
an interface configured to receive from a mobile terminal an electronically watermarked image in which electronic-value information is embedded; and
a controller configured to extract electronic-value information out of the electronically watermarked image, adjusting a payment based on the electronic-value information that is extracted, and updating contents of the received electronic-value information based on the result of the payment adjusting.

11. A payment adjusting apparatus according to claim 10, wherein said controller authenticates the electronically watermarked image received through the interface.

12. A payment adjusting apparatus according to claim 11, wherein said controller authenticates the electronically watermarked image by comparing a value stored in the electronic-value information with an electronic signature into which the stored value is encoded using a cryptographic key.

13. A payment adjusting apparatus according to claim 11, wherein said controller annunciates completion of a process of adjusting a payment, action of the annunciating becoming a trigger to inhibit further transmission of the electronic-value information from a mobile terminal to another mobile terminal after said adjusting means has completed the process of the payment adjustment.

14. A payment adjusting apparatus according to claim 10, wherein said controller decodes the encoded electronic-value information received by receiving means.

15. An electronic watermarked image making out program which allows a computer to realize:
an extracting function of extracting electronic-value information out of an electronically watermarked image in which the electronic-value information is embedded;
a payment adjusting function of adjusting a payment based on an amount of a value in the electronic-value information extracted by the extracting function; and
an updating function of updating contents of the electronic-value information based on a balance resulted from the payment adjustment performed by said payment adjusting function.

16. A program according to claim 15 further realizing an electronic-value authenticating function of authenticating the electronically watermarked image that is received.

17. A program according to claim 16, wherein said electronic-value authenticating function authenticates the electronically watermarked image by comparing value information stored in the electronic-value information with an electronic signature into which the value information is encoded using a cryptographic key.

18. A program according to claim 16 further realizing an annunciating function of annunciating completion of a process of adjusting a payment, action of the annunciating serving as a trigger to inhibit further transmission of the electronic-value information from a mobile terminal to another mobile terminal after said adjusting means has completed the process of the payment adjustment.

19. A program according to claim 15 further realizing a decoding function of decoding the encoded electronic-value information that is received.
